(19) United States
(12) Patent Application Publication
(10) Pub. No.: US 2006/0021489 A1
(43) Pub. Date: Feb. 2, 2006

(54) Spring operated record player organ

(75) Inventor: Lung-Hsi Huang, Dali City (TW)

Correspondence Address: NIKOLAI & MERSEREAU, P.A., 900 SECOND AVENUE SOUTH, SUITE 820, MINNEAPOLIS, MN, 55402, US

(73) Assignee: Kyooh Precision Industry Co., Ltd., Taichung Hsien (TW)

(21) Appl. No.: 10/902,110

(22) Filed: Jul. 29, 2004

(51) Int. Cl. G10F 1/06

(52) U.S. Cl. 84/95.1

(57) ABSTRACT

A spring operated record player organ is set forth, it includes a base apparatus, a driving unit, a gear set, a fixed axle unit, a record player, and a rotation speed governor. By the manipulatively designed component parts in the mechanism. The record player is able to rotate with the stable restoring force of a manually wound up coil spring so as to play rhythmical music pleasant to the ear. As this apparatus does not require electric power, it is conveniently usable anywhere.

### BACKGROUND OF THE INVENTION

1. Field of the Invention

The present invention relates to a spring operated record player organ, and more particularly, to a record player organ which is driven by the restoring force of a comb spring leaf.

2. Description of the Prior Art

Referring to FIG. 4, it is a schematic view of a conventional motor operated record player organ. As shown in FIG. 1, a comb spring leaf 71 is provided on a base apparatus 7, a set pin 72 and a driving motor 73 are respectively installed on each side of the comb spring leaf 71. The driving motor 73 is screw combined with a double herical gear 74, while the double herical gear 74 is screw combined with a ratchet wheel 75. Several pawl wheels 751 and a player driving gears 752 are coaxially installed on the shaft of the ratchet wheel 75 in order. The player driving gear 752 is for driving a record player 77.

The base apparatus 7 which being installed at one side of the motor 73 has a fixed axle 76. A hasp 761 is provided at the end terminal of the fixed axle 76 so as to fasten the fixed axle 76 to the set pin 72.

When it is intended to play music, at first settle the player 77 on the set pin 72, and engage the hasp 761 with the set pin 72 such that the player 77 is set between the ratchet wheel 75 and the fixed axle 76. Next, energize the motor 73 from the power source so as to drive the double herical gear 75 and the player driving gear 752 which in turn drives the player 77 to rotate, and by mutual action between the apertures formed on the player 77 and the driving gear 751 so that the comb spring leaf 71 is actuated to play a rhythmical music.

However, the conventional spring operated record player organ constructed as such has the following shortcomings, namely:

1. A power supply is necessary to operate this apparatus that causes it unable to play where there is no available power source.

2. A electric wiring is necessary in the apparatus that makes its construction complicated and frangible so that a very careful attention for operation and transportation is required.

For these shortcomings noticeable on the prior art, an improvement is seriously required.

The inventor has dedicated great efforts for years to studying and improving these shortcomings and come up with a novel spring operated record player organ as provided in this invention to eliminate the shortcomings mentioned above.

### SUMMARY OF THE INVENTION

It is an object of the present invention to provide a spring operated record player organ which is operated with a spring wound around a rotating shaft so as to drive the player by restoring force of the spring instead of an extra power supply.

Another object of the present invention is to provide a spring operated record player organ whose rotating shaft is constructed in the aspect that it is erected to pierce through the spring cover and the base apparatus. A rotary switch to twist the coil spring is provided on the top end of the rotating shaft so as to wind up the coil spring before rotating the player.

Another object of the present invention is to provide a spring operated record player organ capable of operating only by the restoring force of the spring so that the organ is usable anywhere and anytime without seeking for another power supply.

Another object of the present invention is to provide a spring operated record player organ which does not have to be turned up side down for operation by providing a rotary switch on the spring cover to twist the spring, and the assembly process is facilitated by placing the base apparatus horizontally on a bottom plate when assembling the organ in the mechanism.

To achieve these and other objects mentioned above, the present invention includes a base apparatus, a driving unit, a gear set, a fixed axle unit, a record player, and a rotation speed governor.

The base apparatus is composed of a comb spring leaf, a ratchet wheel shaft on which being provided with equal numbers of actuating ratchet wheels as that of the teeth of the comb spring leaf, and a player driving gear. All of the actuating ratchet wheels and the player driving gear are coaxially coupled to the ratchet wheel shaft. The comb spring leaf and the ratchet wheel shaft are mutually coupled in a state such that the actuating ratchet wheels can tap the teeth of the comb spring leaf to output various octavant musical sound.

The driving unit has a spring cover fitted at one side of the base apparatus, and the spring cover has a rotating shaft piercing through its top surface and a first crown gear is enclosed underneath by the spring cover. A rotary switch is provided at the other side where the rotating shaft is coupled with the first crown gear. A coil spring is wound around the rotating shaft. The rotary switch is to wind up the coil spring. When the rotary switch is released, the restoring force of the coil spring drives the rotating shaft to rotate which in turn drives the first crown gear.

The gear set is equipped between the comb spring leaf and the driving unit. The gear set is composed of a second crown gear, a first step spur gear, a second step spur gear, a double herical gear, and a speed reducer. As the first and second crown gears are in mesh with each other, the rotation of the first crown gear puts the gear set in motion which in turn drives the ratchet wheel shaft thereby all the ratchet wheels are actuated to tap the comb spring leaf.

The fixed axle unit is provided with a set pin and a fixed axle. The set pin is located in the base apparatus at the position distantly apart from the driving unit and extended in the direction apart from the base apparatus. One end of the set pin is pivoted to the spring cover, while the other end thereof is provided with a hasp to fasten the fixed axle in parallel with the ratchet wheel shaft. Besides, several rotating wheels are fitted with the fixed axle coaxially in series.

A record player with a drilled hole formed at its center allows the set pin to pierce through. The record player is provided with a plurality of tapping apertures distributed at random on its surface, and a plurality of driving holes are formed around the record player at the positions near its fringe such that when the record player is driven to rotate by the player driving gear, the driving holes formed around the fringe of the record player will never fail to mesh the player driving gear since the record player is properly pressed by the rotating wheels of the fixed axle.

The rotation speed governor is provided beneath the bottom apparatus and the driving unit. It is composed of a speed stabilizing cam and a speed stabilizing wheel. The speed stabilizing cam is mated with the rotating shaft at the end distantly apart from the rotary switch for the coil spring, on the other hand the speed stabilizing wheel is in mesh with the speed stabilizing cam. With the aid of the rotation speed governor, the operation of the mechanism is difined to take place during the time interval the restoring force of the coil spring is at the best stable state thereby the music can be played pleasantly to the ear with stabilized rotating speed of the mechanism.

### BRIEF DESCRIPTION OF THE DRAWINGS

The drawings disclose an illustrative embodiment of the present invention which serves to exemplify the various advantages and objects hereof, and are as follows:

FIG. 1 is an illustrative exploded view of the present invention;

FIG. 2 is another illustrative exploded view of the present invention;

FIG. 3 is a perspective view of the present invention observed downwardly;

FIG. 4 is a schematic view of a conventional spring operated record player organ.

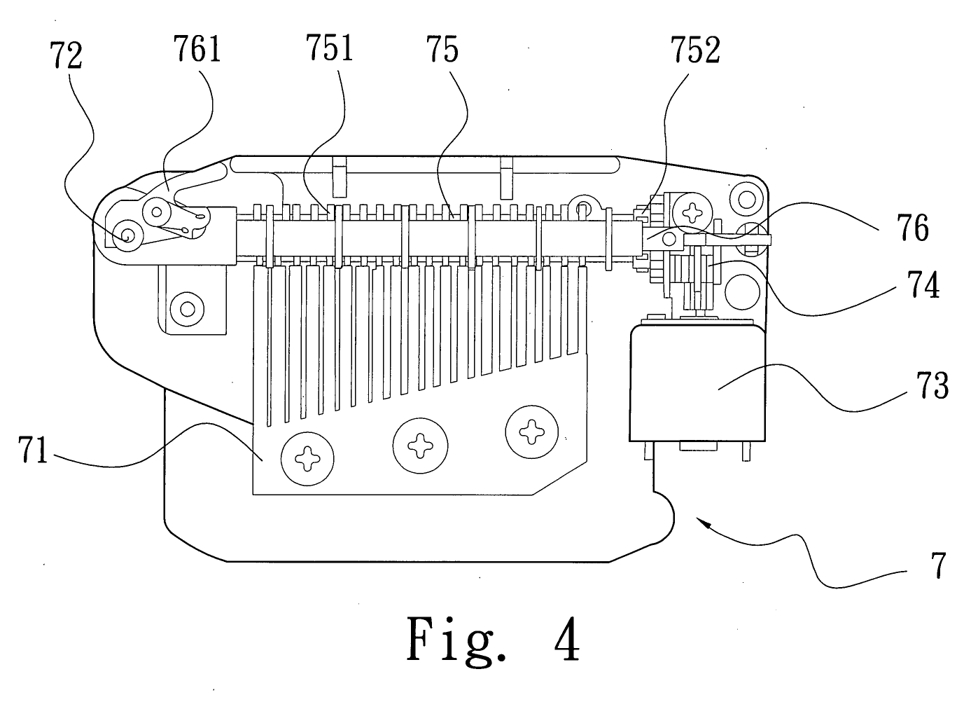

### DETAILED DESCRIPTION OF THE PREFERRED EMBODIMENT

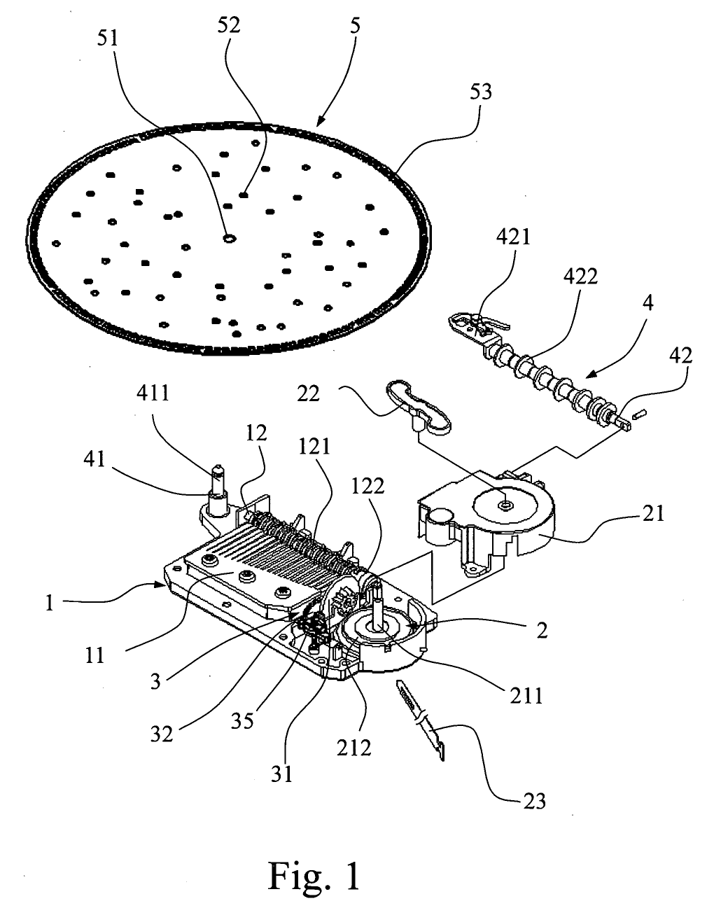

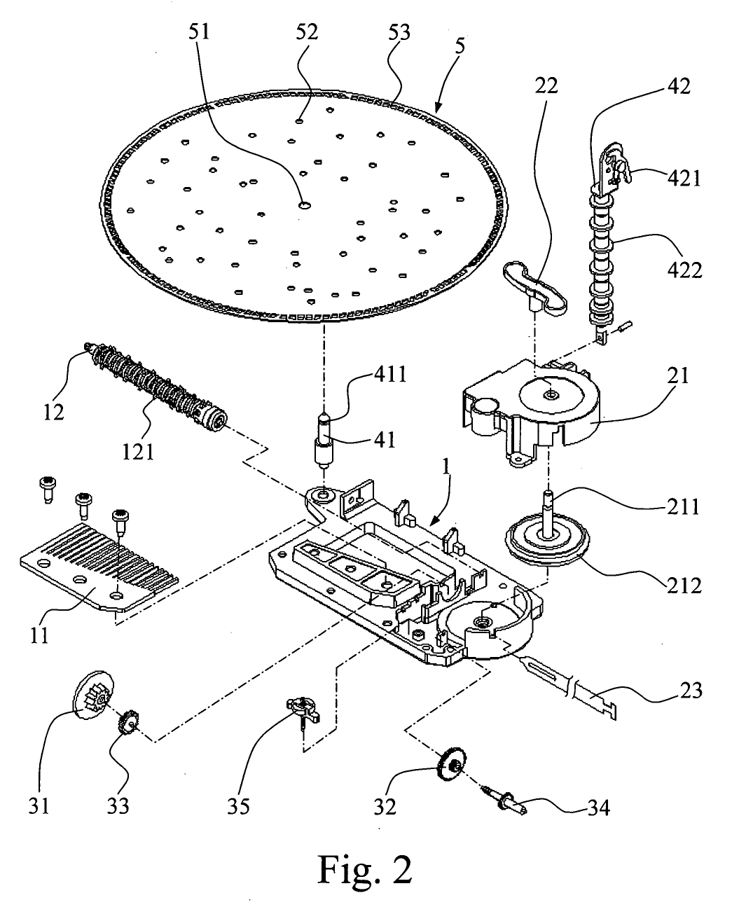

Referring to FIG. 1 through FIG. 3, The spring operated record player organ comprises a base apparatus 1, a driving unit 2, a gear set 3, a fixed axls unit 4, a record player 5, and a rotation speed governor 6.

The base apparatus 1 is composed of a comb spring leaf 11 and a ratchet wheel shaft 12. The ratchet wheel shaft 12 is provided with actuating wheels 121 and a player driving gear 122. Both of them are coaxially fitted to the ratchet wheel shaft 12. The comb spring leaf 11 are equipped at a position where it can be tapped by the actuating wheels 121 to output a rhythmical music when the ratchet wheel shaft 12 rotates.

The driving unit 2 has as spring cover 21 fitted at one side of the base apparatus 1, and the spring cover 21 has a rotating shaft 211 piercing through its top surface and a first crown gear 212 is enclosed underneath by the spring cover 21. A rotary switch 22 is provided at the other side where the rotating shaft 211 is coupled with the first crown gear 212. A coil spring 23 is wound around the rotating shaft 211, while the rotary switch 22 is to wind up the coil spring 23. When the wound coil spring 23 is released, the restoring force of the coil spring 23 drives the rotating shaft 211 which in turn drives the first crown gear 212.

The gear set 3 is equipped between the comb spring leaf 11 and the driving unit 2. The gear set 3 is composed of a second crown gear 31, a first step spur gear 32, a second step spur gear 33, a double herical gear 34, and a speed reducer 35. As the first and second crown gears 212 and 31 are in mesh with each other, the rotation of the first crown gear 212 puts all component parts in cluded in the gear set 3 (second crown gear 31, first step spur gear 32, second step spur gear 33, double herical gear 34, speed reducer 35) in motion. The second step spur gear 33 which being mated with the second crown gear 31 then in turn drives the ratchet wheel shaft 12 thereby all the ratchet wheels 121 are actuated to tap the comb spring leaf with a proper rotating speed under control of the speed reducer 35.

The fixed axle unit 4 is provided with a set pin 41 and a fixed axle 42. The set pin 41 is located in the base apparatus 1 at the position distantly apart from the driving unit 2 and extended towards the direction apart from the base apparatus 1. One end of the set pin 41 is pivoted to the spring cover 21, while the other end thereof is provided with a hasp 421 to be inlaid into a circular slot 411 formed around the upper portion of the set pin 41 so as to fasten the fixed axle 4 in parallel to the ratchet wheel shaft 12. Besides, several rotating wheels 422 are fitted with the fixed axle 42 coaxially in series.

A record player 5 with a drilled hole 51 formed at its center to allow piercing the set pin 41 through is provided with a plurality of tapping apertures 52 distributed at random on its surface, and a plurality of driving holes 53 are formed around the record player 5 at the position near its fringe thereof such that when the record player 5 is driven to rotate by the player driving gear 122, the driving holes 53 are able to mate the player driving gear 122 surely since the record player 5 is properly pressed by the rotating wheels 422 of the fixed axle 42.

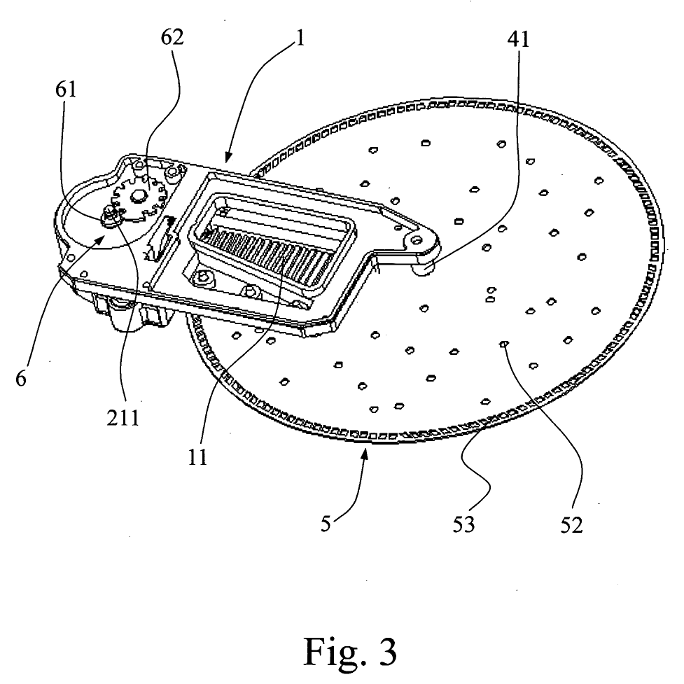

The rotation speed governor 6 is provided beneath the base apparatus 1 and the driving unit 2. As shown in FIG. 3, it is composed of a speed stabilizing cam 61 and a speed stabilizing wheel 62. The cam 61 is mated with the rotating shaft 211 at the end distantly apart from the rotary switch 22 for the coil spring 23, on the other hand, the wheel 62 is in mesh with the cam 61. With the aid of the rotation speed governor 6, the operation of the mechanism is difined to take place during the time interval the restoring force of the coil spring 23 is at its best stable condition thereby the music can be played pleasantly to the ear with a stabilized rotating speed of the record player 5.

The speed stabilizing wheel 62 of the rotation speed governor has a plurality of equally sized, equally spaced, similarly shaped teeth and one differently shaped tooth, and the number of similarly shaped teeth is in match with the length of the coil spring and the stable restoring force acting time interval of the coil spring.

To operate the mechanism of the present invention, put the mechanism on a platform or a desk; then release the hasp 421 from the circular slot 411 formed around the set pin 41; then insert the drilled hole 51 of the record player 5 into the set pin 41 and again inlay the hasp 421 into the circular slot 411 so as to mate the player driving gears 122 on the ratchet wheel shaft 12 with the driving holes 53 formed along the fringe of the record player 5, and with the aid of the rotating wheels 422 of the fixed axle 42 to properly press onto the record player 5 so that the driving holes 53 keep in mesh with the gears 122 without the worry of disengagement; then rotate the rotary switch 22 to twist the coil spring 23 winding around the rotating shaft 211 thereby storing the energy in the twisted coil spring 23.

After releasing the rotary switch 22, the mutually mated speed stabilizing wheel 62 and cam 61 begin to rotate together until reaching the last tooth the coil spring 23 is able to drive the first and second crown gear 212 and 31 depending on its own restoring force. The gear set 3 is in turn actuated to rotate and drive the player driving gear 122 so that the record player 5 is driven to rotate. As the record player 5 rotates, the combined action of the driving holes 53 and the actuating wheels 121 makes the latter to tap the comb spring leaf 11 to output a pleasant rhythmical music. For stabilizing the operation of the mechanism of the present invention, action of the speed stabilizing wheel 62 and cam 61 must well cooperate to define the operation of the mechanism to take place during the time interval the restoring force of the coil spring 23 is at its best stable condition thereby the music can be played pleasantly to the ear.

In addition, the position of the actuating holes 53 on the player 5 can be varied in accordance with the different melody so that its serves the individual user a wide selection.

It emerges from the above description that the spring operated record player organ has several noteworthy advantages compared with that made of any conventional technique, namely:

1. The mechanism is operated by a manually twisted coil spring associated with several gear combination so that any other extra power supply such as the utility power or the battery unit is not necessary.

2. The rotary switch for twisting the coil spring is provided on top of the rotating shaft so it is convenient to wind up the coil spring without tampering with the base apparatus before rotating the record player.

3. The operation of the mechanism is defined to take place during the time interval the restoring force of the coil spring is at its best stable condition thereby the music can be played pleasantly to the ear.

Many changes and modifications in the above described embodiment of the invention can, of course, be carried out without departing form the scope thereof. Accordingly, to promote the progress in science and the useful arts, the invention is disclosed and is intended to be limited only by the scope of the appended claims.

What is claimed is:

1. A spring operated record player organ comprising:
a base apparatus, a driving unit, a gear set, a fixed axle unit a record player, and a rotation speed governor; wherein
said base apparatus is composed of a comb spring leaf, a ratchet wheel shaft on which being provided with equal numbers of actuating ratchet wheels as that of the teeth of said comb spring leaf, and a player driving gear, all of said actuating ratchet wheels and said player driving gear are coaxially coupled to said ratchet wheel shaft, said comb spring leaf and said ratchet wheel shaft are mutually coupled in a state such that said actuating ratchet wheels can tap the teeth of said comb spring leaf to output various octavant musical sound;
Said driving unit has a spring cover fitted at one side of said base apparatus, and said spring cover has a rotating shaft piercing through its top surface and a first crown gear is enclosed underneath by said spring cover, a rotary switch is provided at the other side where said rotating shaft is couple with said first crown gear, a coil spring is wound around said rotating shaft, said rotary switch is to wind up said coil spring, when said rotary switch is released, the restoring force of said coil spring drives said rotating shaft to rotate which in turn drives said first crown gear;
Said gear set is equipped between said comb spring leaf and said drining unit, said gear set is composed of a second crown gear, a first step spur gear, a second step spur gear, a double herical gear, and a speed reducer, as said first and second crown gears are in mesh with each other, the rotation of said first crown gear puts said gear set in motion which in turn drives said ratchet, wheel shaft thereby all said ratchet wheels are actuated to tap said comb spring leaf;
said fixed axle unit is provide with a set pin and a fixed axle, said set pin is located in said base apparatus at the position distantly apart from said driving unit and extended towards the direction apart from said base apparatus, one end of said set pin is pivoted to said spring cover, while the other end thereof is provided with a hasp to fasten said fixed axle in parallel with said ratchet wheel shaft, besides, several rotating wheels are fitted with said fixed axle coaxially in series;
A record player with a drilled hole formed at its center allows said set pin to pierce through, said record player is provided with a plurality of tapping apertures distributed at random on its surface, and a plurality of driving holes are formed around said record player at the positions near its fringe such that when said record player is driven to rotate by said player driving gear, said driving holes formed around the fringe of said record player will never fail to mesh said player driving gear since said record player is properly pressed by the rotating wheels of said fixed axle;
Said rotation speed governor is provided beneath said bottom apparatus and said driving unit, it is composed of a speed stabilizing cam and a speed stabilizing wheel, said cam is mated with said rotating shaft at the end distantly apart from said rotary switch for said coil spring, on the other hand said speed stabilizing wheel is in mesh with said speed stabilizing cam, with the aid of said rotation speed governor, the operation of the mechanism is defined to take place during the time interval the restoring force of said coil spring is in its best stable condition thereby the music can be played pleasantly to the ear.

2. The spring operated record player organ of claim 1, wherein said speed reducer is equipped between said spring cover and said base apparatus.

3. The spring operated record player organ of claim 1, wherein said speed stabilizing wheel of said rotation speed governor has a plurality of equally sized equally spaced, similarly shaped teeth and one differently shaped tooth, and the number of similarly shaped teeth is in match with the length of said coil spring and the stable restoring force acting time interval of said coil spring.

4. The spring operated record player organ of claim 1, wherein a slot is formed around the upper portion of said set pin for a hasp to be inlaid.
